(19) United States
(12) Patent Application Publication
(10) Pub. No.: US 2014/0101065 A1
(43) Pub. Date: Apr. 10, 2014

(54) Systems and Methods for Providing Business Conduct Training

(71) Applicant: William B. Dickerson, Atlanta, GA (US)

(72) Inventor: William B. Dickerson, Atlanta, GA (US)

(21) Appl. No.: 14/045,475

(22) Filed: Oct. 3, 2013

Related U.S. Application Data
(60) Provisional application No. 61/710,167, filed on Oct. 5, 2012.

(51) Int. Cl. G06Q 10/10

(52) U.S. Cl. CPC G06Q 10/105
USPC 705/320

(57) ABSTRACT

Systems and methods for providing and tracking periodic business-conduct testing and education. The method can include, upon logging into a system, displaying a question related to business conduct and requiring a user to answer the question prior to accessing applications or other content through the system. The question can be derived from the employer's business conduct code or from other applicable law or generally accepted business conduct practices. Questions can be tailored to particular classes of users, external events, or other factors, and can be presented to a user on a regular or tailored schedule. The method can include tracking question and answer data including overall question effectiveness and user-specific statistics. In some implementations, the system can indicate the correct answer to a question after receiving a response. In another implementation, the system can receive feedback such as ratings or comments from a user after responding to the question.

### CROSS-REFERENCE TO RELATED APPLICATIONS

This application claims priority and the benefit under 35 U.S.C. § 119(e) of U.S. Provisional Patent Application No. 61/710,167, filed 5 Oct. 2012, of which the entire contents and substance are hereby incorporated by reference as if fully set forth below.

### TECHNICAL FIELD

Various implementations of the present invention relate to computer-implemented systems and methods for providing business conduct training and tracking the progress thereof.

### BACKGROUND

Corporations and other business entities frequently operate according to a particularized set of rules, principles, or policies known as a code of business conduct. A corporation's code of business conduct typically outlines expectations for employee behavior and may emphasize the corporation's mission or core values. Adhering to a mission or core values can help a business maintain its identity and focus. Frequently, the code of business conduct also includes policies intended to ensure regulatory compliance. For example, many codes of conduct refer to the U.S. Foreign Corrupt Practices Act and other anticorruption laws. Ensuring that employees comply with the code of business conduct can help minimize legal and financial risk. Moreover, in some situations, implementing a business code of conduct in itself can be a means to limiting risk exposure. For example, having and disseminating a business code of conduct can be evidence that an employer exercised reasonable care in the workplace. Thus, an increasing number of businesses are requiring employees to attend seminars and other training regarding business conduct.

Conventional methods of business conduct training include providing static study materials to employees such as written handbooks and videotapes. However, these materials can be costly to keep up-to-date. Moreover, these materials tend to be passive, requiring little user interaction. Conventional training methods also include seminars and other forms of in-person training However, in-person training can be time consuming and inconvenient. Moreover, individualized training can be expensive for an employer while large class sizes can disturb the day-to-day operations of a business. Each of the above-mentioned training methods can impose an administrative burden on the employer to track attendance, participation, and effectiveness.

Computer-implemented training methods can address many of the above-mentioned issues, but conventional computer-implemented training methods still fall short in important ways. For example, previous computer-implemented training methods administer training to employees at inopportune times, such as during or in lieu of work. Requiring an employee to complete a training session during these times can be disruptive and interfere with work objectives. Thus, conventional methods of business conduct training fail to eliminate the workplace distraction posed by mandatory employee training.

### SUMMARY

Some or all of the above needs may be addressed by certain implementations of the present invention. Certain implementations of the present invention can help ensure user participation in the provided training by presenting a question to the user upon the user logging into the system. The method can include requiring the question to be answered before allowing the user to access applications or other content through the system. Presenting a question upon user logon is beneficial because it enables training during the course of an employee's workday without disrupting or interfering with work objectives.

According to an example implementation, a method is provided. The method may include receiving an indication of a request to log on to a computer system, the log-on request associated with a first employee. The method may further include determining, by a processor and based on the user request, a work-related classification associated with the first employee. The method may yet further include outputting, for display and based on the work-related classification, a training question for answering by the first employee. The method may also include responsive to receiving an indication of an answer to the training question, permitting the log on to the computer system.

Other implementations, features, and aspects of the present invention are described in detail herein and are considered a part of the disclosed invention. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 depicts a block diagram of an illustrative computing device architecture 100, according to an example implementation.

FIG. 2 depicts a flow diagram of a method for providing business conduct training 200, according to an example implementation.

### DETAILED DESCRIPTION

Various implementations of the present invention relate to computer-implemented systems and methods for providing business conduct training and tracking the results thereof. For example, one implementation of the present invention can help ensure that an employee engages in periodic business conduct testing and education.

To facilitate an understanding of the principles and features of implementations of the invention, various example implementations are explained below. Although example implementations of the invention are explained in detail, other implementations are contemplated. Further, in describing the example implementations, specific terminology will be resorted to for the sake of clarity. It is not intended that the invention be limited in scope to the details of construction and arrangement of components set forth in the following description or illustrated in the drawings. Rather, the invention is capable of other implementations and of being practiced or carried out in various ways.

In the following description, numerous specific details are set forth. However, it is to be understood that implementations of the present invention may be practiced without these specific details. In other instances, well-known methods, structures and techniques have not been shown in detail in order not to obscure an understanding of this description. References to “one implementation,” “an implementation,” “example implementation,” “some implementations,” “certain implementations,” “various implementations,” etc., indicate that the implementation(s) of the present invention so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Various aspects described herein may be implemented using standard programming or engineering techniques to produce software, firmware, hardware, or any combination thereof to control a computing device to implement the disclosed subject matter. A computer-readable medium may include, for example: a magnetic storage device such as a hard disk, a floppy disk or a magnetic strip; an optical storage device such as a compact disk (CD) or digital versatile disk (DVD); a smart card; and a flash memory device such as a card, stick or key drive, or embedded component. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the claimed subject matter.

Various devices, systems, and apparatus may be used to provide the business conduct training methods, according to example implementations of the present invention, and will now be described with reference to the accompanying figures.

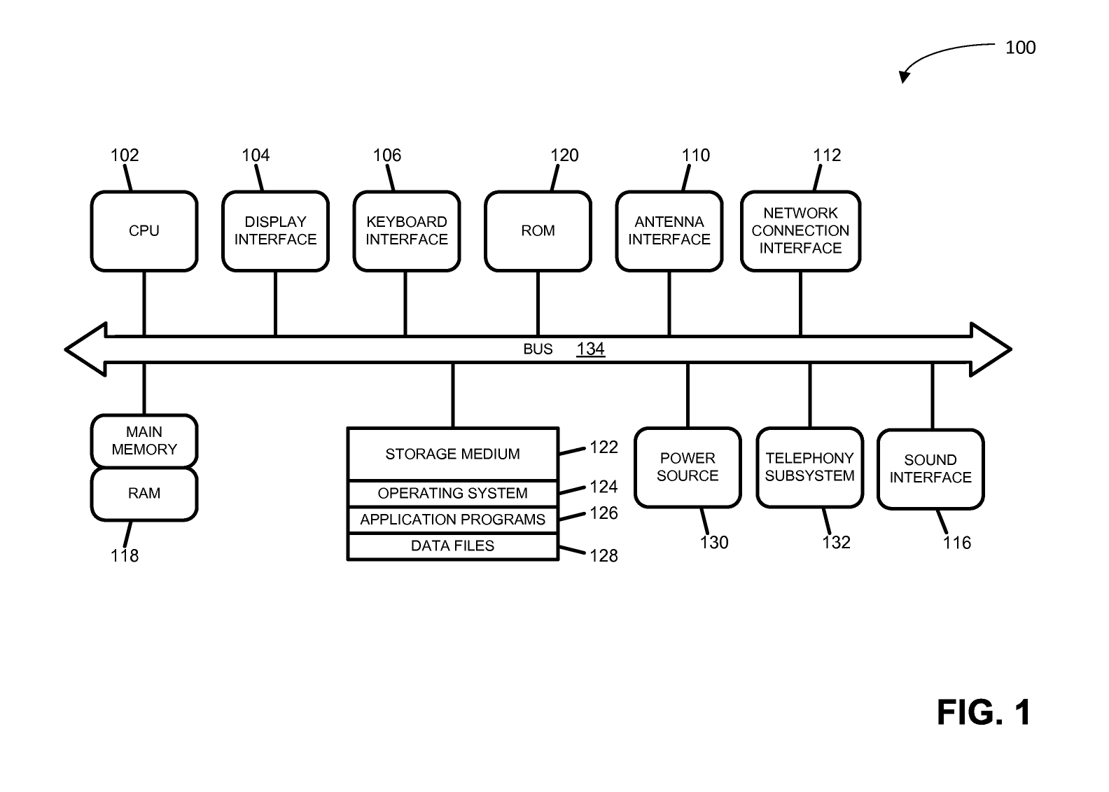

FIG. 1 depicts a block diagram of an illustrative computing device architecture 100, according to an example implementation. Certain aspects of FIG. 1 may be embodied in a computer device or system. As desired, implementations of the present invention may include a computing device with more or less of the components illustrated in FIG. 1. It will be understood that the computing device architecture 100 is provided for example purposes only and does not limit the scope of the various implementations of the present disclosed systems, methods, and computer-readable mediums.

The computing device architecture 100 of FIG. 1 includes a central processing unit (CPU) 102, where computer instructions are processed; a display interface 104 that acts as a communication interface and provides functions for rendering video, graphics, images, and texts on the display. In certain example implementations of the present invention, the display interface 104 may be directly connected to a local display. In another example implementation, the display interface 104 may be configured for providing data, images, and other information for an external/remote display that is not necessarily physically connected to the computing device.

The computing device architecture 100 may be configured to use an input device via one or more of input/output interfaces (for example, the keyboard interface 106, the display interface 104, network connection interface 112, camera interface 114, sound interface 116, etc.,) to allow a user to capture information into the computing device architecture 100. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 100 or may be a separate device. For example, the input device may be an accelerometer, a magnetometer, a digital camera, a microphone, and an optical sensor.

Example implementations of the computing device architecture 100 may include an antenna interface 110 that provides a communication interface to an antenna; a network connection interface 112 that provides a communication interface to a network. The display interface 104 may be in communication with the network connection interface 112, for example, to provide information for display on a remote display that is not directly connected or attached to the system. In certain implementations, a sound interface 116 is provided as a communication interface for converting sound into electrical signals using a microphone and for converting electrical signals into sound using a speaker. According to example implementations, a random access memory (RAM) 118 is provided, where computer instructions and data may be stored in a volatile memory device for processing by the CPU 102.

According to an example implementation, the computing device architecture 100 includes a read-only memory (ROM) 120 where invariant low-level system code or data for basic system functions such as basic input and output (I/O), startup, or reception of keystrokes from a keyboard are stored in a non-volatile memory device. According to an example implementation, the computing device architecture 100 includes a storage medium 122 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 124, application programs 126 (including, for example, a web browser application, a widget or gadget engine, and or other applications, as necessary) and data files 128 are stored. According to an example implementation, the computing device architecture 100 includes a power source 130 that provides an appropriate alternating current (AC) or direct current (DC) to power components. According to an example implementation, the computing device architecture 100 includes and a telephony subsystem 132 that allows the device 100 to transmit and receive sound over a telephone network. The constituent devices and the CPU 102 communicate with each other over a bus 134.

According to an example implementation, the CPU 102 has appropriate structure to be a computer processor. In one arrangement, the CPU 102 may include more than one processing unit. The RAM 118 interfaces with the computer bus 134 to provide quick RAM storage to the CPU 102 during the execution of software programs such as the operating system application programs, and device drivers. More specifically, the CPU 102 loads computer-executable process steps from the storage medium 122 or other media into a field of the RAM 118 in order to execute software programs. Data may be stored in the RAM 118, where the data may be accessed by the computer CPU 102 during execution. In one example configuration, the device architecture 100 includes at least 228 MB of RAM, and 256 MB of flash memory.

The storage medium 122 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 122, which may comprise a machine-readable storage medium.

Certain implementations of the present invention can help ensure user participation in the provided training by presenting a question to the user upon the user logging into the system. The method can include requiring the question to be answered before allowing the user to access applications or other content through the system. Presenting a question upon user logon is beneficial because it enables training during the course of an employee's workday without disrupting or interfering with work objectives.

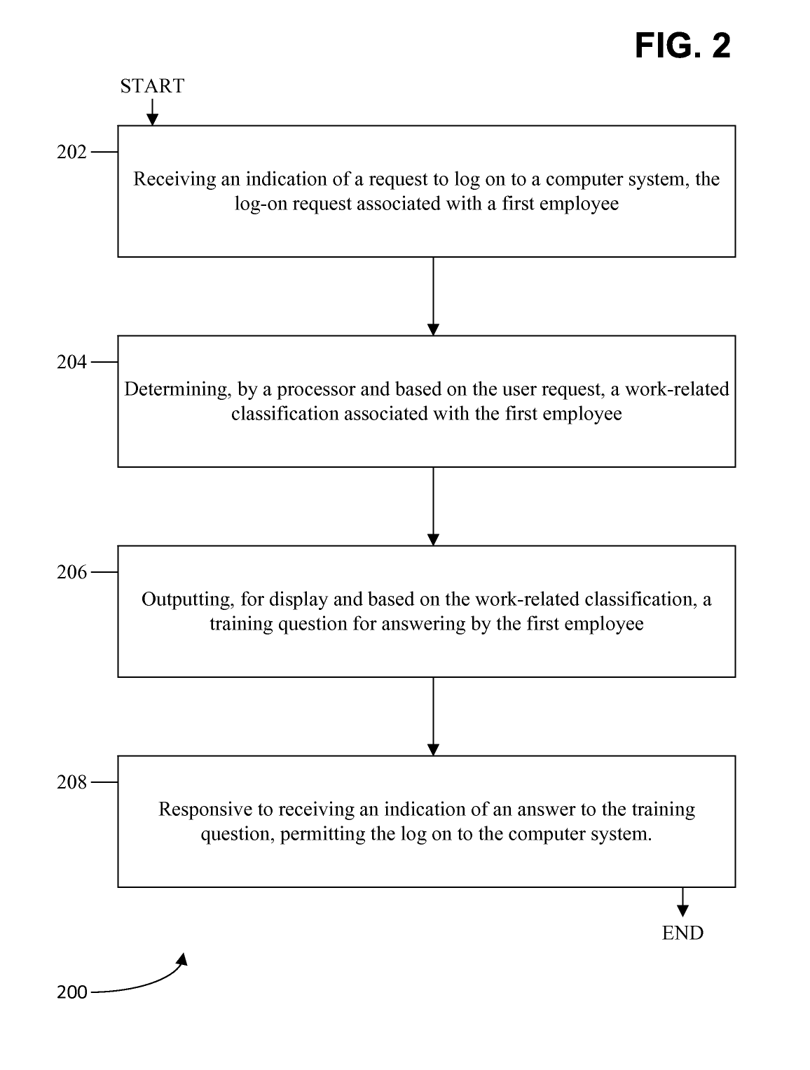

FIG. 2 depicts a flow diagram of a method for providing business conduct training 200, according to an example implementation. As shown in FIG. 2, the method 200 starts in block 202, and, according to an example implementation, includes receiving an indication of a request to log on to a computer system, the log-on request associated with a first employee. In block 204, the method 200 includes determining, by a processor and based on the user request, a work-related classification associated with the first employee. In block 206, the method 200 includes outputting, for display and based on the work-related classification, a training question for response by the first employee. In block 208, the method 200 includes responsive to receiving an indication of an answer to the training question, permitting the log on to the computer system.

It will be understood that the various steps shown in FIG. 2 are illustrative only, and that steps may be removed, other steps may be used, or the order of steps may be modified.

In certain implementations, the question can be presented as one or more of a combination of text, video, audio, or any other suitable manner of conveying a question to a user. For example, the question can be displayed to a user as text for viewing on a display operatively connected to the system.

In an example implementation, the user can be an employee, and the question can be derived from an employer's business conduct code. Alternatively, the question can be based on generally accepted businesses practices, laws, or regulations applicable to the employer or employee.

In certain implementations, the questions presented can be based on particular classes of users, external events, or other factors. For example, the system can present a specific set of questions to users classified as managers. In an example implementation, a user can be associated with multiple classes or roles, and the classes associated with the user can change.

In another implementation, questions can be presented to a user on a regular or tailored schedule. Although a question can be presented to a user each time the user logs on to the system, it is not necessary to do so. For example, in one implementation a user can be required to answer a presented question at every other logon. In another implementation, a user can be required to answer a question only at the first logon of each day. Moreover, not every question presented to a user at logon has to be mandatory. In one implementation, only the first question presented to a user each day may require a response.

In another implementation, a user can choose to be presented with an additional question after answering a first question. The additional question can be mandatory as well, but does not have to be. In another implementation, a user can choose to view a second question without answering the first question, but may still be required to answer at least one of the first and second questions before the system allows access. In another implementation, the method may not allow access to the system until a correct answer is received. By presenting a limited number of questions, the employee may not be unnecessarily delayed.

In another implementation, the system can indicate the correct answer to a presented question after receiving an answer. For example, after presenting a question and receiving an incorrect answer, the system can display the correct answer for viewing by a user.

In certain implementations, the method can also include tracking the progress of user training For example, certain implementations can monitor the answers to the questions received from users. The question and answer data can be global or user-specific. For example, in one implementation, the system can collect global data on overall question effectiveness. In another implementation, the system can collect user-specific data such as a percentage of questions answered correctly by the user. Collected statistics can also be collected or aggregated by time, user class or role, or various other criteria. Tracking the progress of user training is beneficial because it enables the manager of the system to oversee the questions and results in a manner that enables him to provide appropriate feedback to employees.

In another implementation, after receiving an answer from a user, the method can receive feedback or other information from the user. For example, in one implementation, the method can receive ratings or comments about the question or answer.

In certain implementations, a user can be associated with a unique identifier. In one implementation, the unique identifier can be determined from the login information associated with the user. For example, in one implementation, an employee's login can be intercepted through a login script present on the system or through other means. Alternatively, another implementation can require a user to self-identify with one or more unique descriptors.

Certain implementations of the present invention are described above with reference to block and flow diagrams of systems and methods and/or computer program products according to example implementations of the present invention. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some implementations of the present invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks. As an example, implementations of the present invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

While certain implementations of the present invention have been described in connection with what is presently considered to be the most practical and various implementations, it is to be understood that the present invention is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the present invention, including the best mode, and also to enable any person skilled in the art to practice certain implementations of the present invention, including making and using any devices or systems and performing any incorporated methods. The patentable scope of certain implementations of the present invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
receiving an indication of a request to log on to a computer system, the log-on request associated with a first employee;
determining, by a processor and based on the user request, a work-related classification associated with the first employee;
outputting, for display and based on the work-related classification, a training question for answering by the first employee; and
responsive to receiving an indication of an answer to the training question, permitting the log on to the computer system.
